(19) United States
(12) Patent Application Publication
(10) Pub. No.: US 2026/0342376 A1
(43) Pub. Date: Oct. 29, 2026

(54) METHODS AND APPARATUS TO MITIGATE COMMON MODE NOISE IN AN ELECTRONIC CIRCUIT

(71) Applicant: Texas Instruments Incorporated, Dallas, TX (US)

(72) Inventors: Aman Gupta, Bangalore (IN); Tarunvir Singh, Richardson, TX (US); Sreeram Subramanyam Nasum, Bangalore (IN)

(21) Appl. No.: 19/402,582

(22) Filed: Nov. 26, 2025

Related U.S. Application Data
(60) Provisional application No. 63/793,774, filed on Apr. 24, 2025.

(51) Int. Cl. H04B 1/44; G05F 1/575

(52) U.S. Cl. CPC H04B 1/44; G05F 1/575

(57) ABSTRACT

In an embodiment, an apparatus includes: a first voltage regulator coupled to a first ground; and a first voltage sense circuit configurable to inject current into an output of the first voltage regulator based on a change in a first voltage difference between the first ground and a second ground.

### CROSS-REFERENCE TO RELATED APPLICATION

This patent application claims the benefit of and priority to U.S. Provisional Patent Application No. 63/793,774, filed Apr. 24, 2025, which is hereby incorporated herein by reference in its entirety.

### TECHNICAL FIELD

This disclosure relates generally to an electronic system and method, and, in particular embodiments, to a method and apparatus to mitigate common mode noise in an electronic circuit.

### BACKGROUND

In some electronic systems, particularly those involving level translation or isolation, circuits may include multiple ground potential references. This approach facilitates the independent management of noise and voltage domains within a single integrated circuit or system, allowing for greater design flexibility and improved overall system performance. This architecture often involves transmitting signals between different voltage domains, which can be beneficial for achieving isolation or adapting to varying power supply levels. The use of multiple ground references enables a more granular control over voltage levels and contributes to a more efficient and adaptable electronic design.

### SUMMARY

In accordance to an embodiment, an apparatus includes: a first voltage regulator coupled to a first ground; and a first voltage sense circuit configurable to inject current into an output of the first voltage regulator based on a change in a first voltage difference between the first ground and a second ground.

In accordance to an embodiment, an apparatus includes: a switch having a first terminal coupled to a supply terminal; a resistor having a first terminal coupled to a second terminal of the switch, and a second terminal coupled to a first ground; a common mode noise detector circuit including an output configurable to provide an indication of common mode noise detection; and a logic circuit having a first input coupled to the first terminal of the resistor and a second input coupled to the output of the common mode noise detector circuit.

In accordance to an embodiment, a receiver includes: an amplifier; a voltage sense

circuit configurable to: detect a change in voltage potential between a first ground associated with the receiver and a second ground associated with a transmitter; and cause a modification of a gain level of the amplifier based on the change.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a block diagram of an example environment in which an example level translator operates to convert a voltage level from a first system to a voltage level of a second system, according to an embodiment of the present disclosure;

FIG. 2 is a block diagram of an example implementation of the level translator of FIG. 1, according to an embodiment of the present disclosure;

FIGS. 3-6 illustrate an example circuit implementation of the level translator of FIG. 1, according to an embodiment of the present disclosure;

FIG. 7 is a circuit diagram of an example implementation of the direct current (DC) path circuit of FIGS. 1, 2 and/or 5, according to an embodiment of the present disclosure;

FIG. 8 illustrates an example implementation of the transistors of FIG. 7, according to an embodiment of the present disclosure; and

FIG. 9 is a graph comparing output of the transmitter of FIG. 2 with and without the common mode noise control of the circuit of FIG. 2, according to an embodiment of the present disclosure.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments

may be obtained without one or more of the specific details, or with other methods, components, materials and the like. In some cases, known structures, materials or operations are not shown or described in detail so as not to obscure the different aspects of the embodiments. References to “an embodiment” or “an example” in this description indicate that a particular configuration, structure or feature described in relation to the embodiment is included in at least one embodiment. Consequently, phrases such as “in one embodiment” or “in some examples” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Embodiments of the present disclosure are described in specific contexts, e.g., an automotive environment. Some embodiments may be used in other environments, such as industrial automation environments, medical device environments, telecommunication environments, consumer electronic environments, power supply environments, etc.

While a circuit that employs multiple ground levels provides benefits such as independent management of noise and voltage domains within a single integrated circuit or system, such circuits may present challenges for reliable signal transmission, potentially leading to data corruption and system malfunction. One problem that may occur in circuits with multiple ground levels is Common Mode Transient (CMT) noise. CMT events occur when there’s a rapid change in the potential difference between two ground planes within an electronic system (e.g., ground level shift, ground bounce, etc.). CMT noise typically happens due to external noise sources or power supply fluctuations impacting the grounds differently. As a result of such noise, current flows between the transmitting (TX) and receiving (RX) sides of a circuit, often through coupling capacitors, which can cause a droop in the TX output voltage. This voltage drop weakens the transmitted signal, potentially reducing it below the threshold required for correct reception and leading to data bit errors. Furthermore, current imbalances during these events can create spurious signals within the circuit’s DC path, which can be misinterpreted as valid data at the receiver, exacerbating the problem of data corruption.

In an embodiment, CMT sensing is provided for circuits (e.g., multi-ground level circuits) to boost transmission output during CMT events. In some circuits that include a DC

path for keep alive during constant input signals, the CMT sensing additionally or alternatively masks glitches in the DC path at signal reception that results from CMT events. In some examples, the methods and apparatus may additionally or alternatively increase receiver gain (e.g., a baseline DC voltage level) during CMT events.

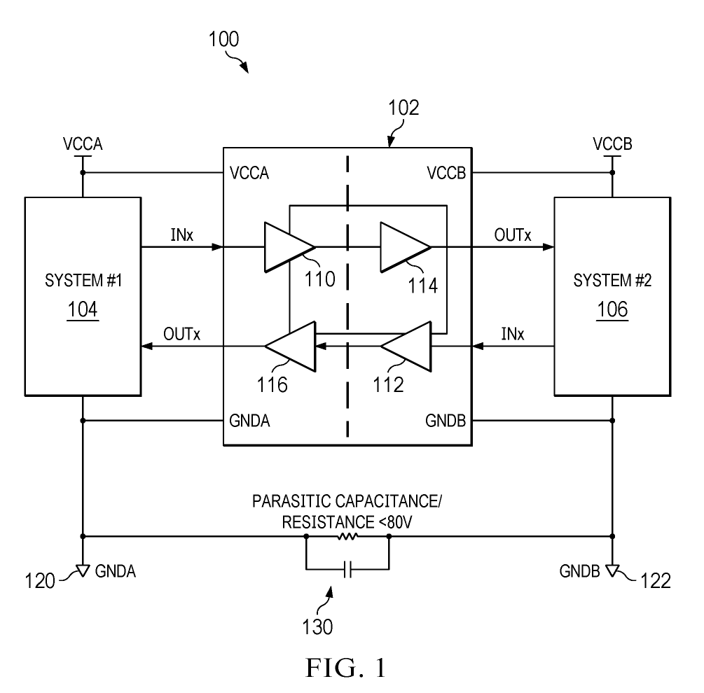

FIG. 1 is a block diagram of example system 100 (also referred to as environment 100), according to an embodiment of the present disclosure. In environment 100, level translator 102 operates to convert a voltage level from first system 104 to a voltage level of second system 106. Level translator 102 includes transmitters 110, 112 and receivers 114,116. Environment 100 includes first ground 120 and second ground 122. FIG. 1 includes a representation of the parasitic capacitance 130 formed between first system 104 includes first ground 108. Second system 106 includes second ground 122.

In normal operation, level translator 102 detects CMT events and boost the transmitter output, masks glitches in a DC/Keep alive signal path, and dynamically adjusts a DC operating point of a receiver gain stage. Level translator 102 performs the noted CMT event compensations in both the path from first system 104 to second system 106 and the path from the second system 106 to first system 104. While the example level translator 102 performs the three identified CMT event compensations, another implementation of level translator 102 may include only one or two of the noted compensations.

First system 104 and second system 106 may be any types of devices, systems, circuits, etc. that are configured to communicate with each other via level translator 102. For example, systems 104, 106 may be systems of an industrial automation environment, a medical device environment, a telecommunication environment, a consumer electronic environment, a power supply environment, etc.

First system 104 is supplied with first supply voltage VccA and coupled to first ground 120 supplies an input signal to level translator 102. Transmitter 110 of level translator 102 transmits the input signal from the VccA/ground voltage domain to receiver 114 at voltage domain VccB/ground. The signal from receiver 114 is output to second system 106 operating at VccB/ground 122 ground level. A signal from second system 106 is also supplied back to first system 104 via transmitter 112 and receiver 116. Because ground 120 and ground 122 can be at different ground levels (e.g., 80 volts offset), parasitic capacitance/resistance 130 is formed between first system 104 and second system 106. The parasitic capacitance/resistance 130 may result in a CMT. During CMT events where a transmit side ground is moving up with respect to a receive side ground, common mode current will flow from a transmitter to a receiver through alternating current (AC) signal coupling between the transmitter and receiver.

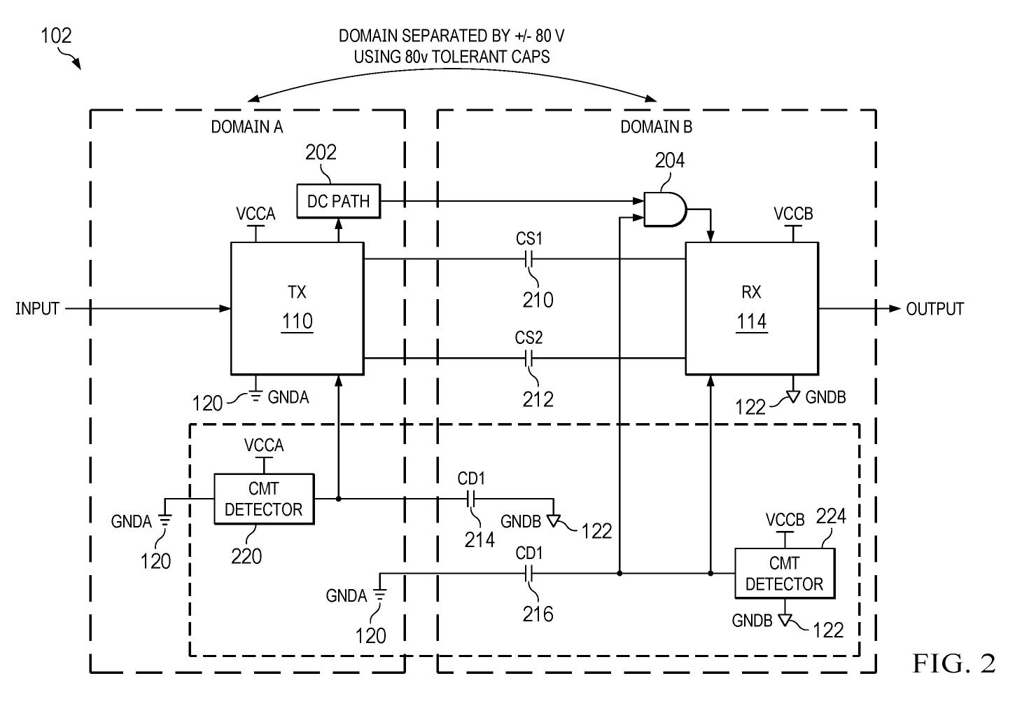

Due to finite bandwidth of transmitter 110, output voltage droops which reduces the transmitted data signal strength. This droop may result in a bit miss if output from transmitter 110 becomes lower than a bit-level threshold of receiver 114. To offset the drop, level translator 102 includes a circuit to detect CMT events and boost output from transmitter 110. An example implementation of level translator 102 including CMT detection and transmitter boost is further illustrated and described, e.g., in FIGS. 2-6.

Level translator 102 includes a DC path to transmit a signal from first system 104 to second system 106 to carry static logic levels from the transmitter to the receiver across the two ground domains, enabling the receiver to see pre-power-up or static data that cannot pass through AC coupling capacitors. During CMT events, a parasitic capacitance forms within the DC path to supply sufficient current to flip a signal from 0 to a supply voltage or a supply voltage to 0. Level translator 102 includes a circuit to detect the CMT event and mask the DC path in response to the detection. An example implementation of level translator 102 including CMT detection and DC path masking is further illustrated and described, e.g., in FIGS. 2-6.

Level translator 102 also includes a circuit to detect CMT events and, in response, to adjust a DC operating level of receiver 114 or receiver 116. An example implementation of level translator 102 including CMT detection and receiver gain adjustment is further illustrated and described, e.g., in FIGS. 2-6.

Level translator 102 is a bi-directional ground-level translator. Alternatively, level translator 102 may be a single direction translator or any other type of translator that could experience CMT events and noise.

In some embodiments, system 100 may be implemented in a monolithic substrate as part of an integrated circuit. In some embodiments, system 100 may be implemented in a discrete manner. Other implementations may be possible.

FIG. 2 is a schematic diagram of an example implementation of level translator 102, according to an embodiment of the present disclosure. Level translator 102 of FIG. 2 includes transmitter 110 and receiver 114 (transmitter 112 and receiver 116 are not illustrated), first ground 120 and second ground 122, DC path circuit 202, AND gate 204, capacitors 210-216, first CMT detector circuit 220 and second CMT detector circuit 224.

In normal operation, an input signal is received by level translator 102 and transmitted by transmitter 110 via AC signal coupling capacitors 210, 212 to receiver 114. Transmitter 110 is at a first ground level of first ground 120 and receiver 114 is at a second ground level of second ground 122, which may cause CMT noise that may interfere with the reception of the data by the receiver. CMT detector 220 detects the CMT noise via AC signal coupling capacitor 214 and boosts the output of transmitter 110 (e.g., injects a current). CMT detector 224 also detects CMT noise via AC coupling capacitor 216 and masks output of the DC path 202 by sending a low signal to block the output of DC path 202 at AND gate 204. CMT detector 224 also adjusts a DC operating point of a gain stage of receiver 114 in response to the CMT noise. For example, CMT detector 224 may drive an additional current source into receiver 114 to raise a DC bias and gain during a CMT event (e.g., a ground-bounce event).

Capacitors 210-216 are 100 volt tolerant capacitors. Alternatively, other capacitors may be utilized depending on the requirements for tolerance to domain voltage differential.

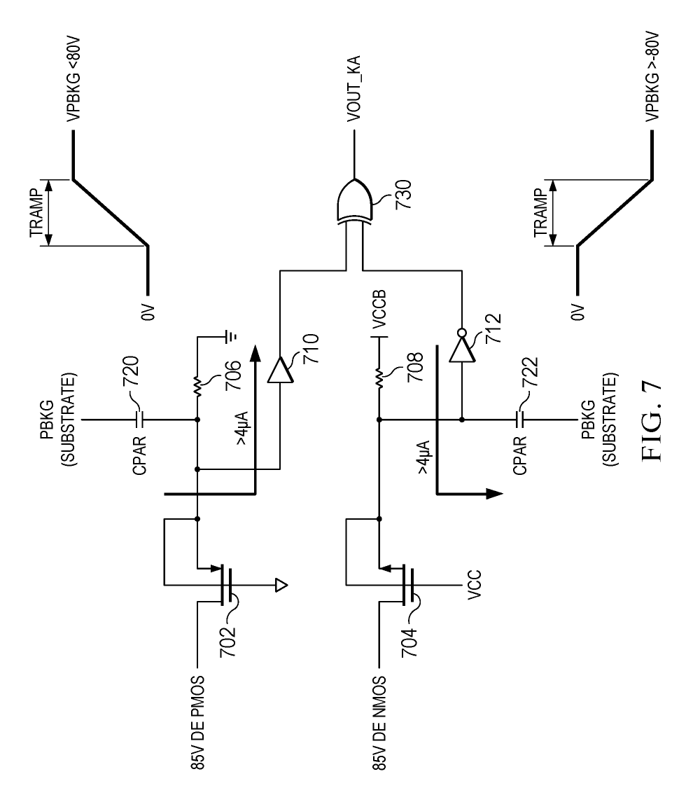

AND gate 204 passes a signal from DC path circuit 202 when CMT detector 224 is not sending a low signal to mask the output from DC path circuit 202. Alternatively, another logic gate may replace AND gate 204 depending on the output characteristics of DC path 202 and CM detector 224. An example implementation of DC path circuit 202 is further illustrated and described, e.g., in FIG. 7.

First CMT detector 220 and second CMT detector 224 are examples of common mode noise detector circuit. In some embodiments, CMT detector 220 and/or 224 may be implemented in any way known in the art.

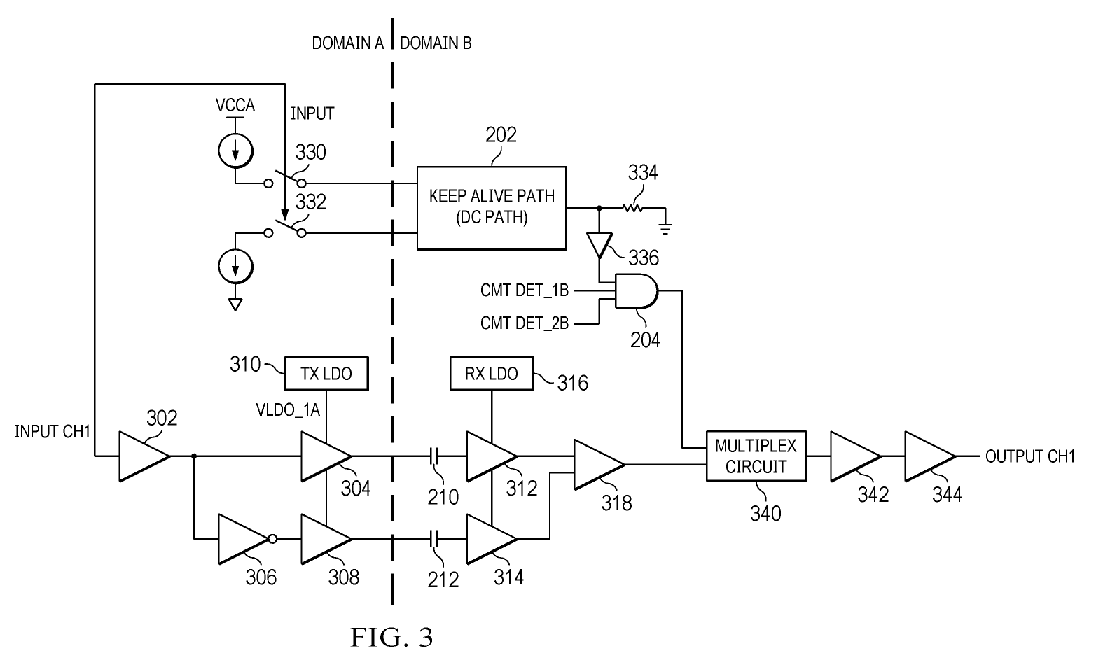

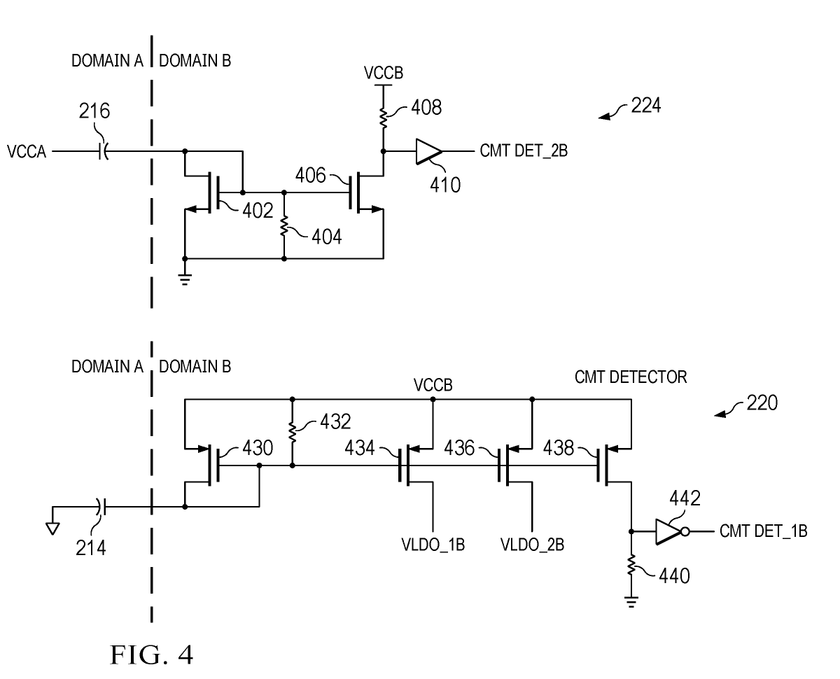

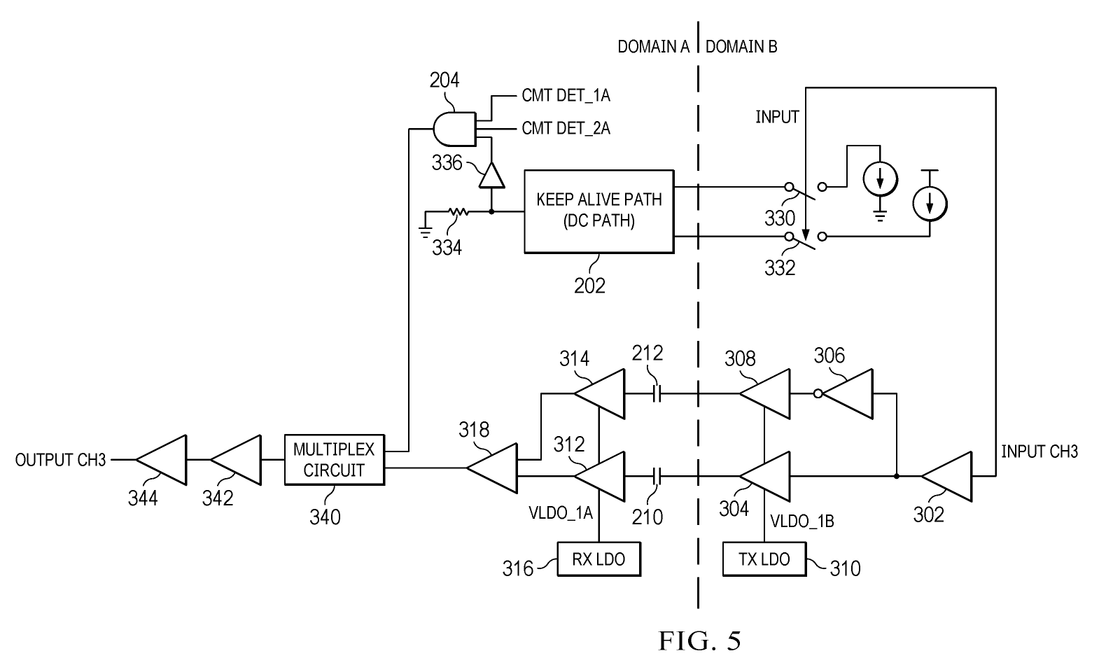

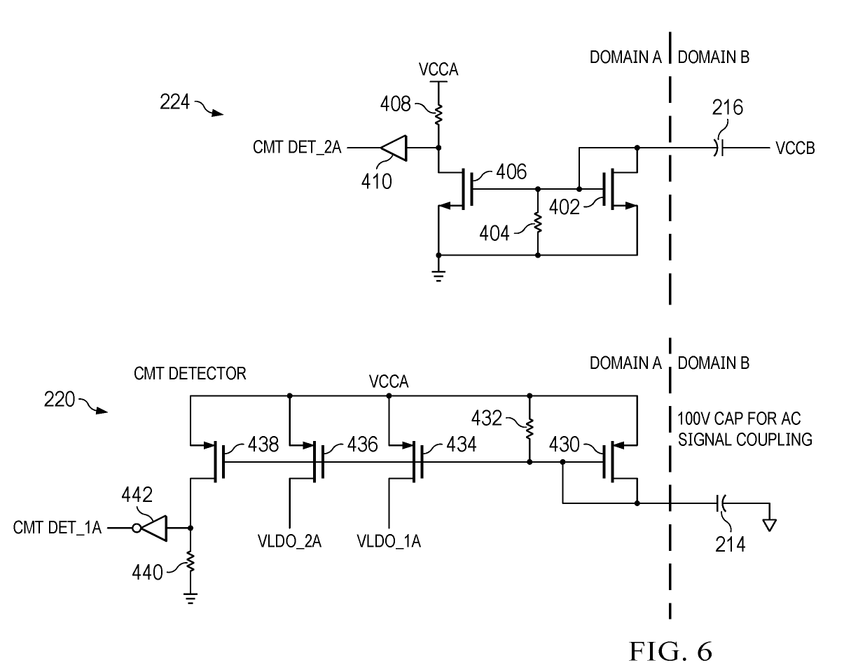

FIG. 3 is a schematic diagram of an example implementation of a transmission path from Domain A to Domain B of level translator 102, according to an embodiment of the present disclosure. FIG. 4 is a schematic diagram of an example implementation of CMT detectors 220, 224, according to an embodiment of the present disclosure. FIG. 5 is a schematic diagram of an example implementation of a transmission path from Domain B to Domain A of level translator 102, according to an embodiment of the present disclosure. FIG. 6 is a schematic diagram of an example implementation of CMT detectors 220, 224, according to an embodiment of the present disclosure.

The transmission path illustrated in FIG. 3 may be combined with the transmission path illustrated in FIG. 5 to implement a bidirectional level translator. In some examples, two transmission paths from Domain A to Domain B may be included in level translator 102 for a two-channel input signal. In some such examples, two transmission paths from Domain B to Domain A may also be included in level translator 102 for a two-channel input signal in the other direction. Because the elements of FIG. 3 are the same as the elements of FIG. 5 except in a mirrored direction, the elements of FIG. 5 will not be further described. Similarly, because the elements of FIG. 4 are the same as the elements of FIG. 6 except in a mirrored direction and opposite supply/ground domains, the elements of FIG. 6 will not be further described.

The transmission path of FIG. 3 includes DC path circuit 202; AND gate 204; AC coupling capacitors 210, 212; a cascade of amplifiers 302, 304, 308, 312, 314, 318, 342, and 344; inverting buffer 306; low dropout regulators 310, 316; switches 330, 332, resistors 334, buffer 336; and multiplex circuit 340. CMT detector 224 of FIG. 4 includes capacitor 216, transistors 402, 406, resistors 404, 408, and buffer 410. CMT detector 220 of FIG. 4 includes capacitor 214, transistors 430, 434, 436, and 438; resistors 432, 440; and inverting buffer 442. CMT detectors 220, 224 of FIG. 4 supply signals VLDO_1A, CMT DET_1B, and CMT DET_2B.

In operation, an input signal flows through amplifiers 302, 304, 308, 312, 314, 318, 342, and 344 and AC coupling capacitors 210, 212 to output via the multiplex circuit 340 that multiplexes a signal from DC path circuit 202. The input signal controls the operation of switches 330, 332 to supply a signal to DC path circuit 202. DC path circuit 202 allows current to flow across resistor 334 when the input signal is not changing. The output of DC path circuit 202 flows through buffer 336 to AND gate 204. CMT detector 224 outputs a low signal on CMT DET_2B when the first ground 120 is moving up with respect to second ground 122. CMT detector 220 outputs a low signal on CMD DET_1B when the first ground 120 is moving up with response to second ground 122. In addition, transistor 436 allows current to flow from VCCB to VLDO_1B to supplement the output of low dropout regulator 310. If level translator 102 includes a second transmission channel, transistor 434 allows current to flow from VCCB to VLDO_1B for a low dropout regulator of the second channel.

While CMT detector 220 of FIGS. 4 detects CMT events and supplies CMT DET_1B, VLDO_1B, and VLDO_2B, in other examples, multiple CMT detectors may be utilized (e.g., a first CMT detector to supply VLDO_1B and VLDO_2B and a second CMT detector to supply CMT DET_1B.

FIG. 7 is a schematic diagram of an example implementation of DC path circuit 202, according to an embodiment of the present disclosure. DC path circuit 202 of FIG. 7 includes transistors 702, 704, resistors 706, 708, and buffers 710, 712, and OR gate 730. FIG. 7 also illustrates parasitic capacitance 720, 722 that forms within the transistors 702, 704.

In operation, transistors 702, 704 operate as reverse current blocking diodes such that transistor 702 avoids current from operate a current second ground 122 to VccA and transistor 704 avoids current from first ground 120 to VccB. Transistors 702, 704 are 85 volt depletion mode (DE) p-type metal oxide semiconductor (PMOS) and DE n-type metal oxide semiconductor (NMOS) transistors, respectively. Alternatively, other transistors may be utilized based on the required operating characteristics of an implementation. Transistors 702, 704 provide a current path (e.g., from drain to source or source to drain) between an input (e.g., from switches 330, 332) to resistors 706, 708, respectively. Transistors 702, 704 include a control terminal (e.g., a gate).

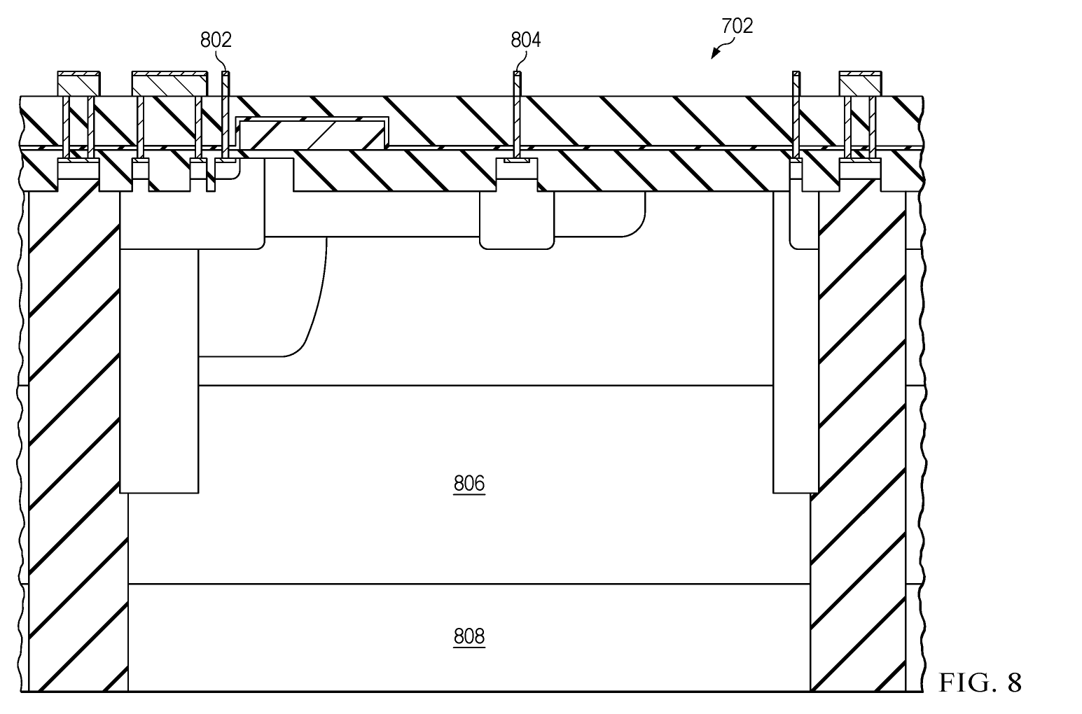

FIG. 8 is a schematic diagram of an example implementation of transistor 702 or transistor 704, according to an embodiment of the present disclosure. Transistor 702 of FIG. 8 includes source 802, drain 804, and N-type buried layer 806 that is a body and is shorted to source 802. The body 806 shorted to source 802 results in a parasitic capacitance between source 802 and substrate 808.

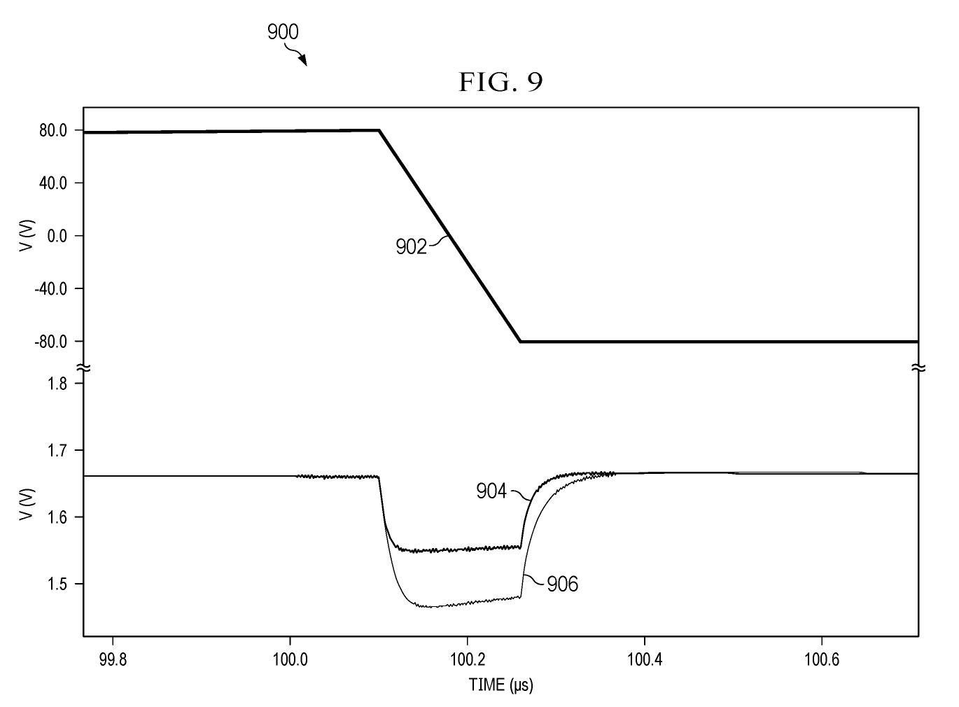

FIG. 9 presents a graph 900 comparing output of the transmitter of FIG. 2 with and without the common mode noise control of the circuit of FIG. 2. Line 902 illustrates second ground 122 dropping with respect to first ground 120. Output of transmitter 110 with CMT event detection and boost is illustrated by line 904 while line 904 illustrates the output without CMT event detection and boost. As shown in FIG. 9, CMT event detection and boost reduces the dip in output of transmitter 110.

While an example manner of implementing level translator 102 of FIG. 1 is illustrated in FIGS. 2-8, one or more of the elements, processes, and/or devices illustrated in FIGS. 2-8 may be combined, divided, re-arranged, omitted, eliminated, and/or implemented in other ways.

Example embodiments of the present disclosure are summarized here. Other embodiments can also be understood from the entirety of the specification and the claims filed herein.

Example 1. An apparatus including: a first voltage regulator coupled to a first ground; and a first voltage sense circuit configurable to inject current into an output of the first voltage regulator based on a change in a first voltage difference between the first ground and a second ground.

Example 2. The apparatus of example 1, further including: a transmitter including the first voltage regulator, the first voltage sense circuit, and the ground.

Example 3. The apparatus of one of examples 1 or 2, where the first voltage sense circuit is configurable to boost an output of the transmitter during a common mode transient event resulting from a shift between the first and second grounds.

Example 4. The apparatus of one of examples 1 to 3, further including a receiver configured to receive data from a transmitter, the receiver including a second ground.

Example 5. The apparatus of one of examples 1 to 4, where the receiver further includes: a second voltage regulator coupled to the second ground; and a second voltage sense circuit configurable to inject current into an output of the second voltage regulator based on a change in a second voltage difference between the first ground and the second ground, where the second voltage regulator is configurable to transmit data.

Example 6. The apparatus of one of examples 1 to 5, where the receiver is configurable to mask an output of a direct current path in response to detection of a change in ground level between the first ground and the second ground.

Example 7. The apparatus of one of examples 1 to 6, where the receiver is configurable to dynamically adjust a direct current operating point of a gain stage of the receiver.

Example 8. The apparatus of one of examples 1 to 7, where the receiver is configurable to: mask an input from the transmitter in response to detection of a change in ground level between the first ground and the second ground; and dynamically adjust a direct current operating point of a gain stage of the receiver.

Example 9. The apparatus of one of examples 1 to 8, where the injected current is proportional to a common mode current that flows from the first ground to the second ground.

Example 10. The apparatus of one of examples 1 to 9, where the first voltage sense circuit includes a capacitor coupled to the second ground.

Example 11. The apparatus of one of examples 1 to 10, where the first voltage sense circuit is configurable to sense the change in a voltage between the first ground and the second ground using the capacitor.

Example 12. The apparatus of one of examples 1 to 11, where the voltage sense circuit includes a current mirror coupled to the capacitor.

Example 13. The apparatus of one of examples 1 to 12, where the current mirror includes two gate connected transistors and a resistor coupled to a supply voltage terminal and the gates of the transistors.

Example 14. The apparatus of one of examples 1 to 13, where the apparatus is a bi-directional ground-level translator.

Example 15. An apparatus including: a switch having a first terminal coupled to a supply terminal; a resistor having a first terminal coupled to a second terminal of the switch, and a second terminal coupled to a first ground; a common mode noise detector circuit including an output configurable to provide an indication of common mode noise detection; and a logic circuit having a first input coupled to the first terminal of the resistor and a second input coupled to the output of the common mode noise detector circuit.

Example 16. The apparatus of example 15, further including a transistor having a current path coupled between the second terminal of the switch and the first terminal of the resistor.

Example 17. The apparatus of one of examples 15 or 16, where the transistor includes a control terminal coupled to a second ground.

Example 18. The apparatus of one of examples 15 to 17, where the logic circuit includes an AND gate having a first input coupled to the first terminal of the resistor and a second input coupled to the output of the common mode noise detector circuit.

Example 19. The apparatus of one of examples 15 to 18, where the common mode noise detector circuit is configurable to output a logic signal based on a change in voltage potential between the first ground and a second ground.

Example 20. The apparatus of one of examples 15 to 19, where the common mode noise detector circuit includes a capacitor, and where the common mode noise detector circuit is configurable to sense the change in voltage potential between the first ground and the second ground using the capacitor.

Example 21. The apparatus of one of examples 15 to 20, where the supply terminal is a first supply terminal, where the resistor is a first resistor, and where the common mode noise detector circuit includes: a first transistor including a first current terminal coupled to a second supply terminal; a second transistor including a first current terminal coupled to the second supply terminal, and a control terminal coupled to a control terminal of the first transistor; a second resistor coupled between a second current terminal of the second transistor and the first ground; a third resistor coupled to the second supply terminal and the control terminals of the first transistor and the second transistor; and a first capacitor coupled between a second current terminal of the second transistor and the second ground.

Example 22. The apparatus of one of examples 15 to 21, where the common mode noise detector circuit further includes: a third transistor including a first current terminal coupled the first ground; a fourth transistor including a first current terminal coupled to the first ground and a gate terminal coupled to a gate terminal of the third transistor; a third resistor coupled between a second current terminal of the third transistor and the first supply; a fourth resistor coupled to the first supply and the gate terminals of the third transistor and the fourth transistor; and a second capacitor coupled between a second current terminal of the fourth transistor and a second supply.

Example 23. The apparatus of one of examples 15 to 22, where the common mode noise detector circuit further includes: a first buffer including an input terminal coupled to the second current terminal of the first transistor and an output terminal coupled to the second terminal of the AND gate; and a second buffer including an input terminal coupled to the second current terminal of the third transistor and an output terminal coupled to a third input terminal of the AND gate.

Example 24. A receiver including: an amplifier; a voltage sense circuit configurable to: detect a change in voltage potential between a first ground associated with the receiver and a second ground associated with a transmitter; and cause a modification of a gain level of the amplifier based on the change.

Example 25. The receiver of example 24, where the voltage sense circuit includes a capacitor coupled to the second ground.

Example 26. The receiver of one of examples 24 or 25, where the voltage sense circuit includes two gate connected transistors and a resistor coupled to a supply voltage and the gates of the transistors.

Example 27. The receiver of one of examples 24 to 26, where the voltage sense circuit is configurable to output a logic signal to control the gain level of the amplifier.

While examples described herein include one or two transmission paths, any number of transmission paths may be implemented in level translator 102. For example, level translator 102 could include two transmission paths from Domain A to Domain B and two transmission paths from Domain B to Domain A. One or more of the CMT event mitigation techniques described herein may be implemented in each transmission path.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. An apparatus comprising:
a first voltage regulator coupled to a first ground; and
a first voltage sense circuit configurable to inject current into an output of the first voltage regulator based on a change in a first voltage difference between the first ground and a second ground.

2. The apparatus of claim 1, further comprising:
a transmitter comprising the first voltage regulator, the first voltage sense circuit, and the ground.

3. The apparatus of claim 2, wherein the first voltage sense circuit is configurable to boost an output of the transmitter during a common mode transient event resulting from a shift between the first and second grounds.

4. The apparatus of claim 1, further comprising a receiver configured to receive data from a transmitter, the receiver comprising a second ground.

5. The apparatus of claim 4, wherein the receiver further comprises:
a second voltage regulator coupled to the second ground; and
a second voltage sense circuit configurable to inject current into an output of the second voltage regulator based on a change in a second voltage difference between the first ground and the second ground, wherein the second voltage regulator is configurable to transmit data.

6. The apparatus of claim 4, wherein the receiver is configurable to mask an output of a direct current path in response to detection of a change in ground level between the first ground and the second ground.

7. The apparatus of claim 4, wherein the receiver is configurable to dynamically adjust a direct current operating point of a gain stage of the receiver.

8. The apparatus of claim 4, wherein the receiver is configurable to:
mask an input from the transmitter in response to detection of a change in ground level between the first ground and the second ground; and
dynamically adjust a direct current operating point of a gain stage of the receiver.

9. The apparatus of claim 1, wherein the injected current is proportional to a common mode current that flows from the first ground to the second ground.

10. The apparatus of claim 1, wherein the first voltage sense circuit includes a capacitor coupled to the second ground.

11. The apparatus of claim 10, wherein the first voltage sense circuit is configurable to sense the change in a voltage between the first ground and the second ground using the capacitor.

12. The apparatus of claim 10, wherein the voltage sense circuit includes a current mirror coupled to the capacitor.

13. The apparatus of claim 12, wherein the current mirror includes two gate connected transistors and a resistor coupled to a supply voltage terminal and the gates of the transistors.

14. The apparatus of claim 1, wherein the apparatus is a bi-directional ground-level translator.

15. An apparatus comprising:
a switch having a first terminal coupled to a supply terminal;
a resistor having a first terminal coupled to a second terminal of the switch, and a second terminal coupled to a first ground;
a common mode noise detector circuit including an output configurable to provide an indication of common mode noise detection; and
a logic circuit having a first input coupled to the first terminal of the resistor and a second input coupled to the output of the common mode noise detector circuit.

16. The apparatus of claim 15, further comprising a transistor having a current path coupled between the second terminal of the switch and the first terminal of the resistor.

17. The apparatus of claim 16, wherein the transistor comprises a control terminal coupled to a second ground.

18. The apparatus of claim 15, wherein the logic circuit comprises an AND gate having a first input coupled to the first terminal of the resistor and a second input coupled to the output of the common mode noise detector circuit.

19. The apparatus of claim 15, wherein the common mode noise detector circuit is configurable to output a logic signal based on a change in voltage potential between the first ground and a second ground.

20. The apparatus of claim 19, wherein the common mode noise detector circuit includes a capacitor, and wherein the common mode noise detector circuit is configurable to sense the change in voltage potential between the first ground and the second ground using the capacitor.

21. The apparatus of claim 15, wherein the supply terminal is a first supply terminal, wherein the resistor is a first resistor, and wherein the common mode noise detector circuit includes:
a first transistor including a first current terminal coupled to a second supply terminal;
a second transistor including a first current terminal coupled to the second supply terminal, and a control terminal coupled to a control terminal of the first transistor;
a second resistor coupled between a second current terminal of the second transistor and the first ground;
a third resistor coupled to the second supply terminal and the control terminals of the first transistor and the second transistor; and
a first capacitor coupled between a second current terminal of the second transistor and the second ground.

22. The apparatus of claim 21, wherein the common mode noise detector circuit further includes:
a third transistor including a first current terminal coupled the first ground;
a fourth transistor including a first current terminal coupled to the first ground and a gate terminal coupled to a gate terminal of the third transistor;
a third resistor coupled between a second current terminal of the third transistor and the first supply;
a fourth resistor coupled to the first supply and the gate terminals of the third transistor and the fourth transistor; and
a second capacitor coupled between a second current terminal of the fourth transistor and a second supply.

23. The apparatus of claim 22, wherein the common mode noise detector circuit further includes:
a first buffer including an input terminal coupled to the second current terminal of the first transistor and an output terminal coupled to the second terminal of the AND gate; and
a second buffer including an input terminal coupled to the second current terminal of the third transistor and an output terminal coupled to a third input terminal of the AND gate.

24. A receiver comprising:
an amplifier;
a voltage sense circuit configurable to:
detect a change in voltage potential between a first ground associated with the receiver and a second ground associated with a transmitter; and
cause a modification of a gain level of the amplifier based on the change.

25. The receiver of claim 24, wherein the voltage sense circuit includes a capacitor coupled to the second ground.

26. The receiver of claim 25, wherein the voltage sense circuit includes two gate connected transistors and a resistor coupled to a supply voltage and the gates of the transistors.

27. The receiver of claim 26, wherein the voltage sense circuit is configurable to output a logic signal to control the gain level of the amplifier.
